(19) United States
(12) Patent Application Publication
(10) Pub. No.: US 2014/0115828 A1
(43) Pub. Date: May 1, 2014

(54) HINGE STRUCTURE WITH CUSHIONING MODULE

(71) Applicant: HON HAI PRECISION INDUSTRY CO., LTD., NEW TAIPEI (TW)

(72) Inventors: FENG-KUN CHENG, NEW TAIPEI (TW); CHIH-CHUNG CHAN, NEW TAIPEI (TW)

(21) Appl. No.: 13/914,320

(22) Filed: Jun. 10, 2013

(30) Foreign Application Priority Data
Oct. 25, 2012 (TW) 101139392

(51) Int. Cl. E05D 7/00

(52) U.S. Cl. CPC E05D 7/00
USPC 16/375; 16/221

(57) ABSTRACT

A hinge structure includes a base, a rotating member and a resilient member. The base includes a cylinder and a piston slidably mounted in the cylinder. Both the resilient member and increasing air pressure in the cylinder below the piston act as a cushioning module to make the rotating member move more and more slowly to the end of the closed position, to cushion the closing of the rotating member and any object it carries.

### BACKGROUND

1. Technical Field

The present disclosure relates to articulating devices, more particularly to a hinge structure of an electronic device.

2. Description of Related Art

Many electronic devices, such as notebook computers, utilize hinge structures. A hinge structure is located between a display and a main body of a notebook computer. To open or close the display relative to the main body, the display is rotatable about a shaft of the hinge structure. However, if an opening force or a closing force is excessive, or if the articulating items snap open or snap shut, the display or the main body is easy to be damaged. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a hinge structure.

FIG. 2 is an isometric view of a piston of the hinge structure of FIG. 1.

FIG. 3 is an isometric view of a cylinder of the hinge structure of FIG. 1.

FIG. 4 is an assembled, isometric view of the hinge structure of FIG. 1.

FIG. 5 is a cross-sectional view taken along a line V-V of the hinge structure of FIG. 4 in an open state.

FIG. 6 is similar to FIG. 5 showing the hinge structure in a closed state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

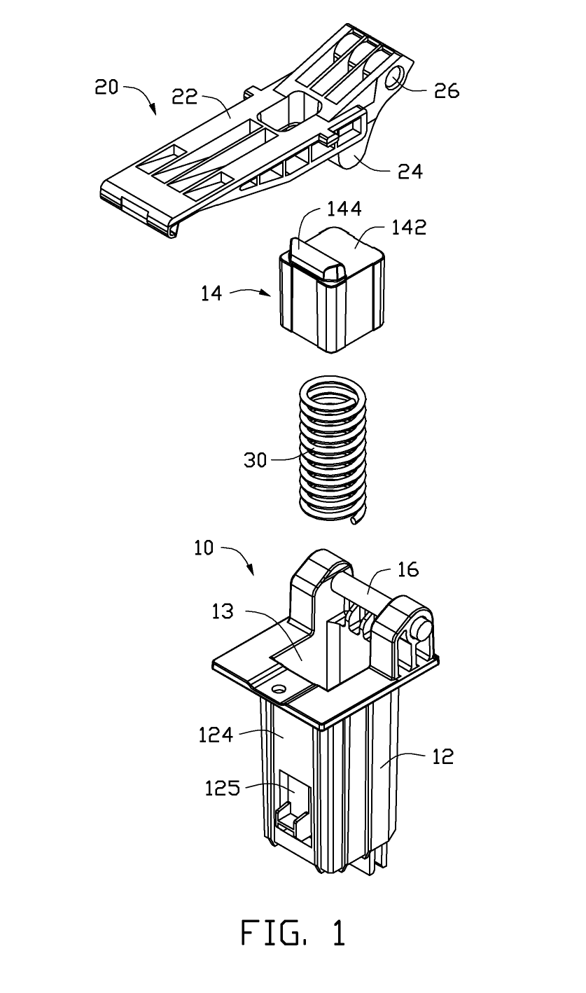

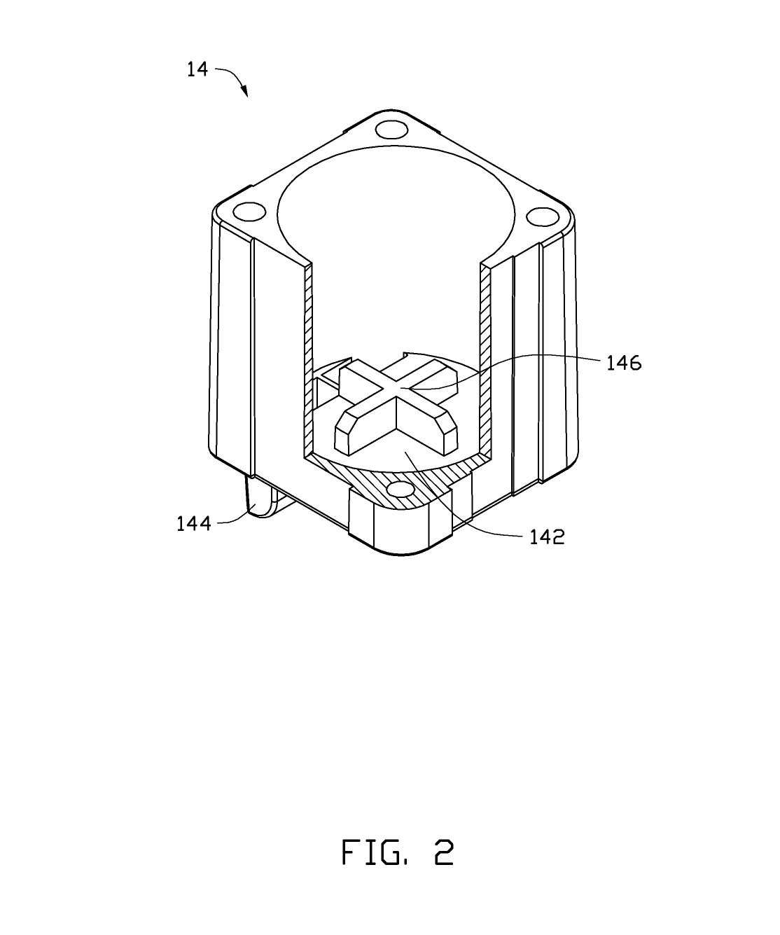

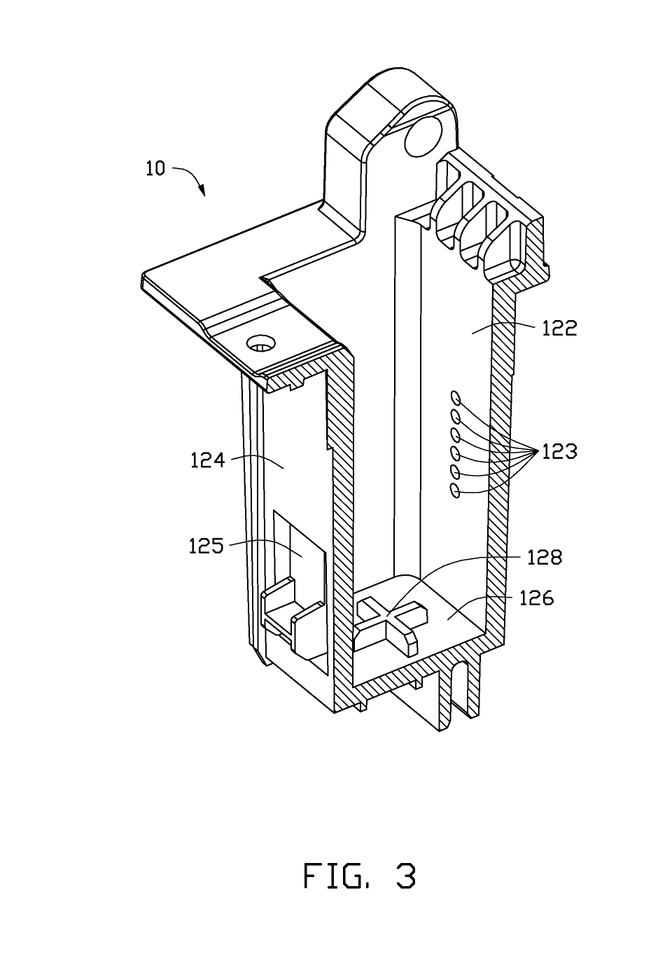

FIGS. 1-3 show a hinge structure in accordance with an embodiment. The hinge structure includes a base 10, a rotating member 20, and a resilient member 30.

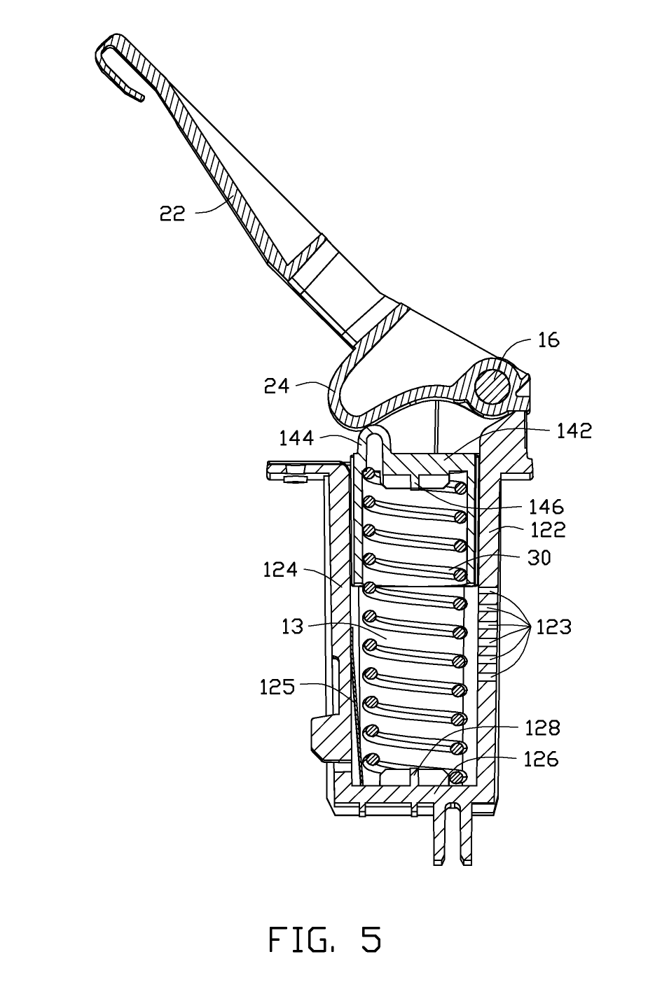

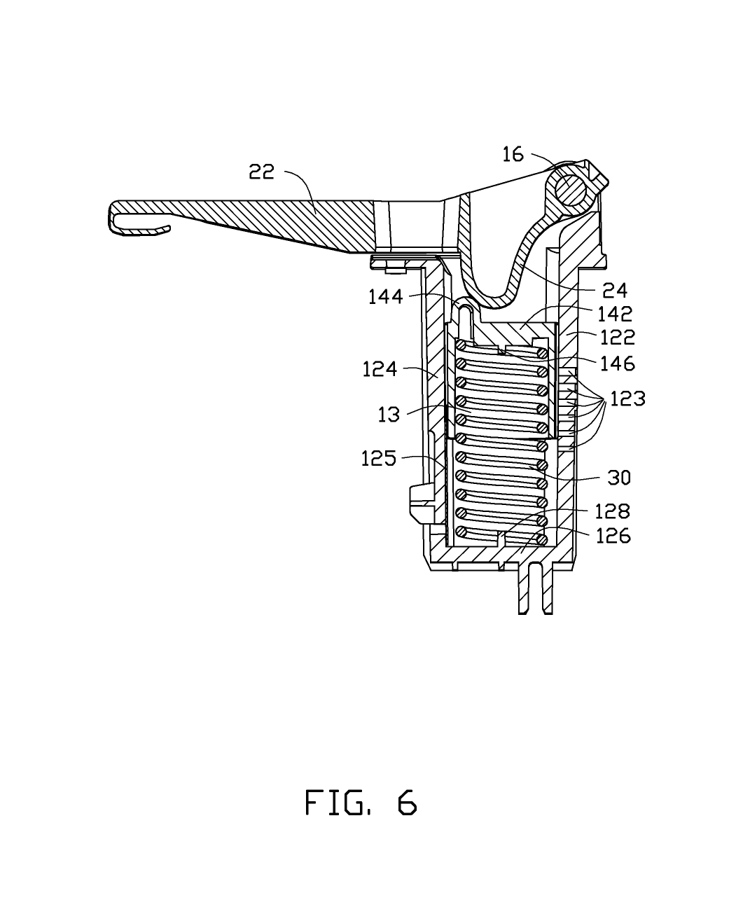

The base 10 includes a cylinder 12 and a piston 14 cooperating with the cylinder 12. In one embodiment, a cross section of the cylinder 12 is rectangular. A cross section of the piston 14 is substantially the same as that of the cylinder 12. Referring to FIG. 5 and FIG. 6, when the piston 14 is engaged with the cylinder 12, a chamber 13 is defined between the piston 14 and the cylinder 12. When the piston 14 is moved in the cylinder 12, the piston 14 compresses or causes reduced air pressure in the chamber 13. In other embodiments, the cross section of the cylinder 12 can be circular, hexagonal or other shape.

The cylinder 12 includes a first sidewall 122, a second sidewall 124 opposite to the first sidewall 122, and a bottom wall 126 connected to the first sidewall 122 and the second sidewall 124. The first sidewall 122 defines a plurality of cushioning holes 123. The cushioning holes 123 are lined along the axial direction of the cylinder 12. The second sidewall 124 defines a one-way valve 125, which can only be opened from inside of the cylinder 12. A distance between the one-way valve 125 and bottom wall 126 is smaller than a distance between the cushioning holes 123 and bottom wall 126. A first limiting portion 128 extends from an inner surface of the bottom wall 126. In one embodiment, the first limiting portion 128 is cruciform.

The piston 14 includes a top plate 142, a driving portion 144 extending from an outer surface of the top plate 142, and a second limiting portion 146 extending from an inner side of the top plate 142. The driving portion 144 has a first outer rim which is curved. In one embodiment, the second limiting portion 146 is cruciform.

The rotating member 20 includes a rotating arm 22 and a cam 24 attached to the rotating arm 22. The rotating arm 22 is oblique relative to the cam 24. The cam 24 defines a pivoting hole 26. The cam 24 has a second outer rim corresponding to the first outer rim. The rotating arm 22 supports or connects to an object (not shown) such as a display. The rotating arm 22 is rotatable to rotate the object or be rotated by the object.

In one embodiment, the resilient member 30 is a compression spring.

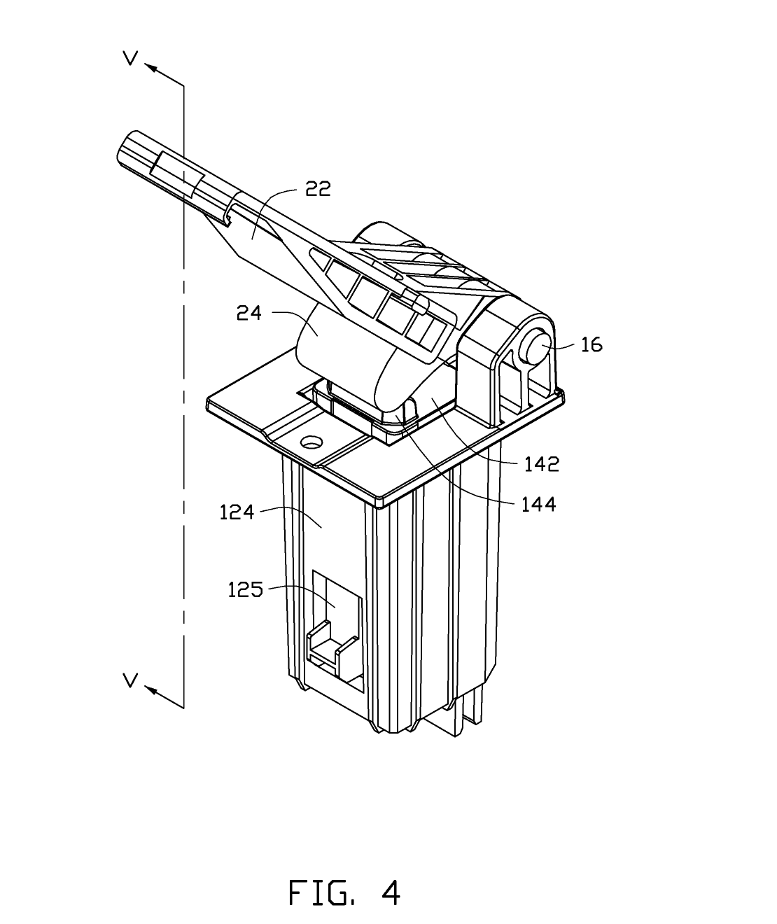

FIG. 4 and FIG. 5 show that, in assembly, the resilient member 30 is placed in the cylinder 12, and then the piston 14 is engaged in the cylinder 12. The resilient member 30 is located between the bottom wall 126 and the top plate 142. The bottom wall 126 and the top plate 142 abut the opposite ends of the resilient member 30. The first limiting portion 128 and the second limiting portion 146 are received in the opposite ends of the resilient member 30. The pivoting shaft 16 is inserted into the pivoting hole 26 and then pivotably mounts the rotating member 20 to the base 10. The second outer rim of the cam 24 abuts the first outer rim of the driving portion 144.

FIG. 5 and FIG. 6 show that, in use, when the hinge structure is to be closed, the rotating arm 22 is moved towards the cylinder 12 about the pivoting shaft 16. The cam 24 presses against the driving portion 144 and moves the piston 14 downwards to elastically deform the resilient member 30. In this process, the one-way valve 125 is closed, discharge of the air in the chamber 13 is allowed from the cushioning holes 123 with a limited speed, to exert a resistance upwards to the piston 14. Thus the piston 14 can only move downwards slowly. Thus, rotating arm 22 rotates towards the cylinder 12 smoothly to prevent damage. Furthermore, the piston 14 covers an increasing number of the cushioning holes 123 when the piston 14 moves downwards, and the discharging speed of the air thus decreases, and the resistance upwards to the piston 14 increases to cushion the motion of the rotating member 20.

When the hinge structure is need to open, the resilient member 30 rebounds to exert a pushing force to slide the piston 14 upwards, and the piston 14 rotates the rotating arm 22 away from the cylinder 12 about the pivoting shaft 16. In this process, the attempted vacuum below the piston 14 exerts a first resistance force to move the piston 14 upwards smoothly, and the pushing force of the spring decreases. Also in this process, the one-way valve 125 is opened, and outside air flows into the chamber 13 below the piston from the cushioning holes 123 and the one-way valve 125. With the piston 14 sliding upwards, more and more of the plurality of cushioning holes are opened, and the attempted vacuum below the piston 14 is reduced by the incoming air. Thus, rotating arm 22 can be rotated away from the cylinder 12 smoothly by the piston 14 to prevent damage.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A hinge structure comprising:
a base comprising a cylinder, a piston slidably mounted in the cylinder, and a chamber defined between the piston and the cylinder;
a rotating member pivotably mounted to the cylinder and abutting the piston; and
a resilient member secured between the piston and a bottom wall of the cylinder;
wherein the rotating member is rotatable relative to the cylinder between an open position and a closed position; when the rotating member is rotated from the open position to the closed position, the rotating member presses the piston along a first direction to elastically deform the resilient member and simultaneously compresses air in the chamber to cause the resilient member and the air to exert a first resistance force to the piston along a second direction opposite to the first direction, to cushion the rotating member; and the resilient member is capable of rebounding to slide the piston along the second direction to rotate the rotating member from the closed position to the open position.

2. The hinge structure of claim 1, wherein the cylinder comprises a first sidewall extending from the bottom wall, and the first sidewall defines a plurality of cushioning holes lined along the first direction.

3. The hinge structure of claim 2, wherein when the piston is slid along the first direction, the piston covers the plurality of cushioning holes one by one, and the first resistance force by the air in the chamber is increased gradually; and when the piston is slid along the second direction, the piston opens the plurality of cushioning holes one by one.

4. The hinge structure of claim 1, wherein the rotating member comprises a cam abutting the piston, when the rotating member is rotated from the open position to the closed position, the cam urges the piston to slide along the first direction.

5. The hinge structure of claim 4, wherein the piston comprises a driving portion abutting the cam, and the driving portion rotates the rotating member from the closed position to the open position when the piston is slid along the second direction.

6. The hinge structure of claim 5, wherein the driving portion has a first arc outer rim, the cam has a second outer rim, and the first arc outer rim abuts the second outer rim.

7. The hinge structure of claim 2, wherein the cylinder further comprises a one-way valve; when the piston is slid along the first direction, the one-way valve is closed, and when the piston is slid along the second direction, the one-way valve is open.

8. The hinge structure of claim 7, wherein the cylinder further comprises a second sidewall opposite to the first sidewall, and the one-way valve is secured to the second sidewall.

9. The hinge structure of claim 7, wherein a distance between the one-way valve and the bottom wall is less than a distance between the plurality of cushioning holes and the bottom wall.

10. The hinge structure of claim 1, wherein the piston comprises a first limiting portion, and the cylinder comprises a second limiting portion; and a first end of the resilient member is secured to the first limiting portion, and a second end of the resilient member is secured to the second limiting portion.

11. A hinge structure comprising:
a base comprising a cylinder, a piston slidably mounted in the cylinder, and a chamber defined between the piston and the cylinder; and
a rotating member pivotably mounted to the cylinder and abutting the piston;
wherein the cylinder defines a plurality of cushioning holes; the rotating member is rotatable relative to the cylinder between an open position and a closed position; when the rotating member is rotated from the open position to the closed position, the rotating member slides the piston along a first direction, and the piston covers the plurality of cushioning holes one by one, and air in the chamber exert a first resistance force increased gradually to the piston along a second direction opposite to the first direction, to cushion the rotating member; and when the rotating member is rotated from the closed position to the open position, air out of the chamber flows into the chamber via the plurality of cushioning holes to push the piston to slide along the second direction.

12. The hinge structure of claim 11, wherein the plurality of cushioning holes are lined along the first direction.

13. The hinge structure of claim 11, further comprising a resilient member secured between the piston and a bottom wall of the cylinder; when the piston slides along the first direction, the piston elastically deforms the resilient member; and the resilient member is capable of rebounding to slide the piston along the second direction to rotate the rotating member from the closed position to the open position.

14. The hinge structure of claim 11, wherein the rotating member comprises a cam abutting the piston, when the rotating member is rotated from the open position to the closed position, the cam urges the piston to slide along the first direction.

15. The hinge structure of claim 14, wherein the piston comprises a driving portion abutting the cam, and the driving portion rotates the rotating member from the closed position to the open position when the piston is slid along the second direction.

16. The hinge structure of claim 15, wherein the driving portion has a first arc outer rim, the cam has a second outer rim, and the first arc outer rim abuts the second outer rim.

17. The hinge structure of claim 13, wherein the cylinder further comprises a one-way valve; when the piston is slid along the first direction, the one-way valve is closed, and when the piston is slid along the second direction, the one-way valve is open.

18. The hinge structure of claim 17, wherein the cylinder further comprises first sidewall extending from the bottom wall and a second sidewall opposite to the first sidewall, the plurality of cushioning holes are defined in the first sidewall, and the one-way valve is secured to the second sidewall.

19. The hinge structure of claim 17, wherein a distance between the one-way valve and the bottom wall is less than a distance between the plurality of cushioning holes and the bottom wall.

20. The hinge structure of claim 13, wherein the piston comprises a first limiting portion, and the cylinder comprises a second limiting portion; and a first end of the resilient member is secured to the first limiting portion, and a second end of the resilient member is secured to the second limiting portion.
